(19) United States
(12) Patent Application Publication
(10) Pub. No.: US 2006/0121422 A1
(43) Pub. Date: Jun. 8, 2006

(54) System and method of providing a virtual foreign language learning community

(76) Inventor: Steve Joseph Kaufmann, West Vancouver (CA)

Correspondence Address: WHITE-WELKER & WELKER, LLC, P.O. BOX 199, CLEAR SPRING, MD, 21722-0199, US

(21) Appl. No.: 11/333,724

(22) Filed: Jan. 17, 2006

Related U.S. Application Data
(63) Continuation-in-part of application No. 11/005,042, filed on Dec. 6, 2004.

(51) Int. Cl. G09B 5/00

(52) U.S. Cl. 434/169

(57) ABSTRACT

The present invention a website providing a virtual online community where learners come to learn languages on the Internet. The initial contact and main point of attraction is the content library. An attractive content area/library/magazine is presented that will encourage learners to want to select and study content and keep coming back to do so. Learners are able to freely download the software that is essentially the Learning Engine. Learners will be able to download freely from a sponsored linguist library content. They will be able to read, listen, and save words and phrases from this content. They will be able to create custom lists of their words and phrases and see useful statistics on all the items they have selected. They will post questions on a Forum. They will also be able to measure their progress.

### TECHNICAL FIELD OF INVENTION

The present invention relates generally to a system and method of providing a virtual foreign language learning community accessible over the Internet and other multi-user networks. More specifically, the system is downloadable software that enables a plurality of Learners to interact in a variety of manners in multiple languages.

### DEFINITIONS

Learner is any registered user of the software, also referred to as a USER.
LingQ is basically the Linguist Learning Engine or Read, Listen, Review whose functionality is enabled by a desktop client software program.
Active LingQ is a content element such as a word or phrased saved by a Learner in the system.
This is essentially a current “word card” as described below with a few modifications.

### BACKGROUND OF THE INVENTION

Increased globalization and technological advances have increased the demands for fluency and literacy in a variety of languages. The desirability and benefits of being multi-lingual have never been greater, creating an overwhelming interest in foreign language learning aids, techniques, and methods.

Traditional learning aids typically include classroom instruction, flash cards, audiocassettes, CDs, magazine, and books. Each of theses traditional teaching aids has their own advantages and disadvantages. For example, classroom instruction provides instant feedback and promotes interaction among learners, but requires students to study pre-determined topics on a set schedule and pace. While the other aids such as flash cards, magazines, and books are relatively inexpensive they do not provide any degree of audible feedback for the learner nor do they provide any degree of feedback correction for mispronunciation or grammar.

More recently web based software programs have become available for teaching and learning foreign languages. The popularity of computer software and web based programs for teaching and learning foreign language has increased along with the proliferation of Internet (web) access and home computers. Computers have a significant advantage over traditional teaching aids since they have the ability to combine text, sound, and graphics that create an interactive learning experience. However, current software programs and web-based systems are developed around pre-determined vocabulary lists and learning schedules or software modules that are designed to teach and develop literacy and fluency in a new language.

Despite the progress that has been made, there is still a need for the development of a web based, learning system that allows a learner to set their own schedule and learning pace by learning a language using content that is of interest to the learner, not pre-determined. Learners spending hours on isolated vocabulary lists do not develop the ability to use or understand this vocabulary in real-life situations. In contrast to the prior art discussed above, the present invention promotes the learning process by providing a language learning system based on increasing vocabulary in a way that is linked to familiar content and therefore can be used in everyday situations. The present invention is based on a system which continually measures and tracks a learner's vocabulary, phrases, and writing mistakes through study on the learner's own time and pace. It integrates the words and phrases learned with content chosen by the learner and written output created by the learner.

The present invention has the potential to accelerate language learning by implementing new techniques that reflect many of the most recent discoveries about how languages are acquired, while avoiding the disadvantages of the traditional didactic methods. The present invention is an integrated, web based, computer system that relies on the well-observed fact that language-learning success depends on motivating and empowering the learner. The learner is asked to read and repetitively listen to authentic content. This is widely recognized to be an effective way to learn a new language if the learner can choose content that is familiar, interesting and at an appropriate level of complexity for the learner.

The present invention improves on the prior art by adding the previously mentioned learning components while allowing the learner to choose the content from a library of topics that are of interest to the learner. This is in stark contrast to the prior art which has content based on topics specifically designed for the language learner which are very often uninteresting and a chore to study. All language learners do not have the same interests or learning ability, which is why this present invention's library provides authentic content on a wide range of subjects, at varying difficulty levels, which the learner can pick from. As well as web based discussions with native speaker coaches on a range of topics that the learner is free to suggest. In this way the learner can almost forget that they are studying a new language as they listen, read, or speak and really try to understand. The learning of proper syntax and vocabulary is facilitated by the integrated and unique features of the system, while the learner pursues subjects of interest.

It is therefore an objective of the present invention to create a free downloadable version of a learning engine that is simple and attractive enough that large numbers of language learners will join and make it ubiquitous.

### SUMMARY OF THE INVENTION

The present invention is an improved method of foreign language learning using a computer for providing web-based learning. The invention is a breakthrough in several important ways. First, it enables the learner to select authentic language content that is suited to the learner's vocabulary level, instead of having to rely on textbooks based on a pre-determined skill level and topic. Secondly, it combines context based vocabulary learning and the individual study of words and phrases through the use of a unique database. A third component links the recognition of phrases in language input (reading and listening) with phrases in language output (writing) and thereby bypasses the conventional teaching of grammar rules. This is reinforced by the use of measurement, which provides motivation for the learner and useful feedback to the teacher.

The emphasis on repetitive input of comprehensible material is a well-known principle of language learning. However, this approach needs to go hand in hand with a systematic and effective way to acquire new vocabulary. The invention recognizes that the acquisition of vocabulary is the single most important process in developing language power. With a large enough vocabulary, the learner can even overcome problems of grammar or syntax and still communicate important concepts. Yet vocabulary acquisition is a complex process. The learner progresses from a passive ability to recognize one meaning of a new word, to a broader understanding of the meanings and nuances of a word, to a level of comfort at using a word, to a confidence in knowing what words are usually associated (collocated) with that word in expressions. This process requires frequent exposure through study and reading, and regular usage of the word in writing and speaking. The integration of listening, reading, tracking, coaching, talking, chatting with proper measurement in one system greatly improves the learner's ability to acquire the target language.

The main objective of the present invention is to create a website site which will be the place to come to learn languages on the Internet. The goal is to have something that is free for Learners and that is fun and attractive and that will spread. In order to make it fun, the initial contact and main point of attraction will be the content library. An attractive content area/library/magazine will be presented that will encourage learners to want to select and study content and keep coming back to do so.

Learners will be able to freely download the software. The software is essentially the Learning Engine. Learners will be able to download freely from a sponsored linguist library content. They will be able to read, listen, and save words and phrases from this content. They will be able to create custom lists of their words and phrases and see useful statistics on all the items they have selected. They will post questions on a Forum. They will also be able to measure their progress. The importing of content will not be included and will be available for a monthly fee. This will be a desktop application that only connects to a system server to download new content. Thus if it becomes ubiquitous increasing support costs are minimized. The software will be available in multiple languages such as, but not limited to: English, French, Chinese, Japanese, Spanish, German, and Italian.

The result will be a software program comprised of a fun, simple interface encouraging sharing. Learners will spread the software since the more Learners there are, the better the language exchange will work. Many people know people in other language groups who would they would encourage to join the language exchange.

### BRIEF DESCRIPTION OF THE DRAWINGS

FIG. 1 illustrates the components of a web-based language learning system;

FIG. 2 illustrates a block diagram of steps used to facilitate web-based language learning;

FIG. 3 illustrates a typical control panel graphical Learner interface (GUI) according to an embodiment of the present invention;

FIG. 4 illustrates interactions of the word card feature according to an embodiment of the present invention;

FIG. 5 illustrates the databases and connectivity in a possible embodiment of the invention;

FIG. 6 illustrates a flow diagram of the writing correction feature of the language learning method;

FIG. 7 illustrates a typical graphical Learner interface (GUI) according to an embodiment of the present invention;

FIG. 8 illustrates the phrase card system.

### DETAILED DESCRIPTION OF THE INVENTION

Method of language learning in which the learner chooses content of interest for listening and reading, storage, and analysis of the learner's words and lexical phrases utilizing personalized databases through interaction with a web based computer system.

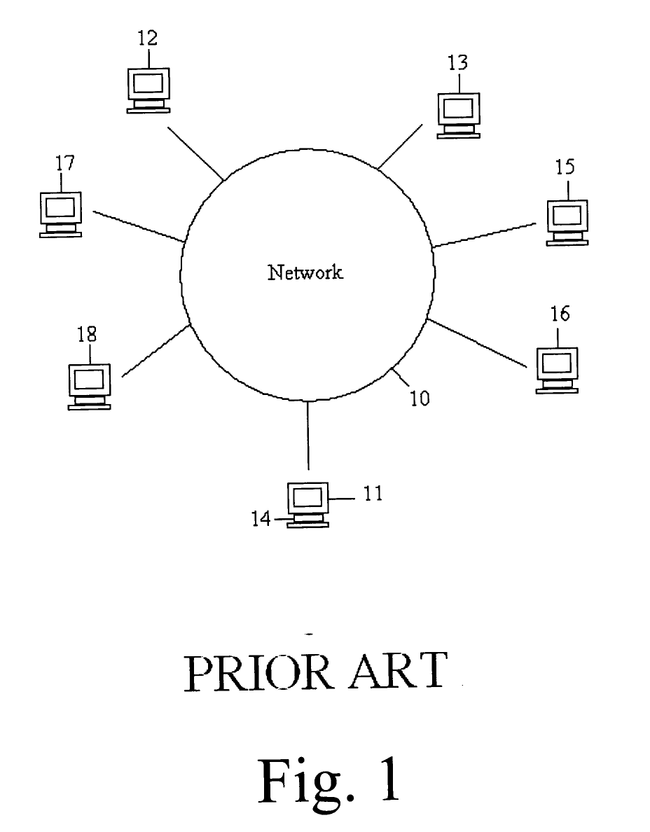

FIG. 1 shows a network of computers 10 that may be used to deliver the web based learning system and method. The network 10 includes a host system 11 that provides access to learner computers 12-13. Each learner computer includes a processor; memory; Learner input device such as microphone, keyboard, and/or mouse; output device such as a speaker, printer, and/or monitor. Leaner computers 12-13 are permitted to communicate with the host system 11 to obtain programs and data stored on the host system 11.

The host computer 11 includes one or more databases 14 for storing the language learning program and data. A large amount of data may be stored on the host computer 11 such as text, audio, video, graphics, animation, illustrations and a dictionary. A learner, while accessing the host computer 11 from a learner computer 12-13 may store information such as word lists, writing samples, and audio samples for review by language coaches. A language coach may access the host system 11 and databases 14 from a language coach computer 15-16 for such purposes as review, analysis, discussion and reading of learner's work. A language coach or learner may access the host computer 11 and databases 14 from any computer 17-18 connect to the Internet from any location.

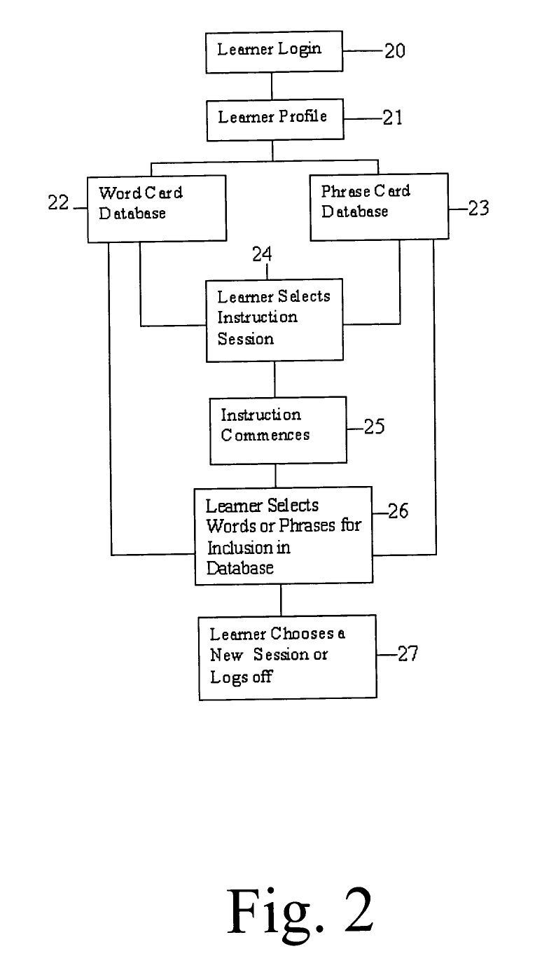

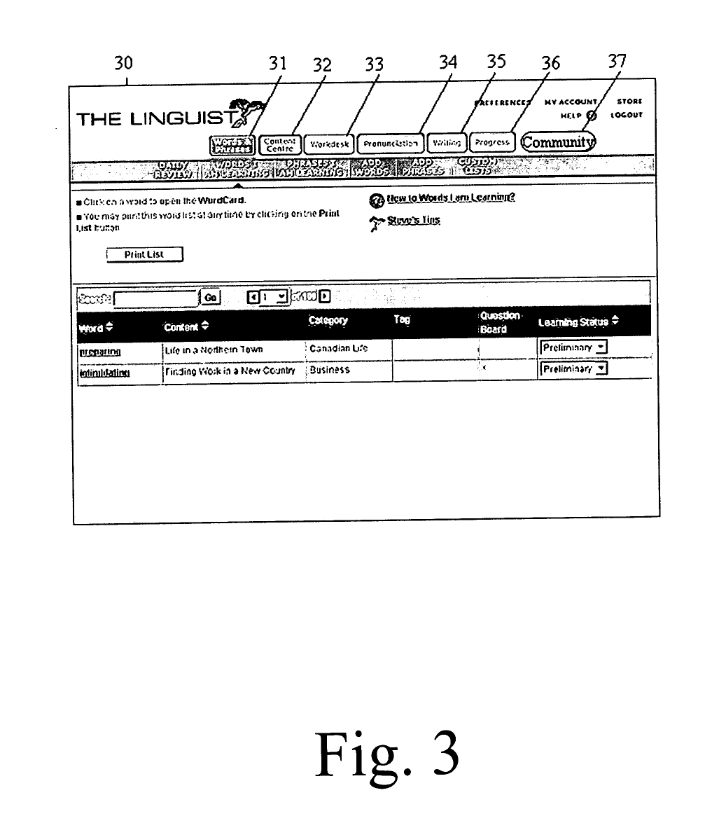

Referring now to FIG. 2, the method includes a learner login 20 through a web based program onto the host computer 11 to commence the learning experience. The host computer 11 accesses a learner profile 21 consisting of a word card database 22 and a phrase card database 23. Once learner login 20 is complete the web based system enables the Learner to select from a control panel 30, as depicted in FIG. 3, possessing a series of selectable instruction sessions that include: Word and Phrases 31, Content Center 32, Workdesk 33, Pronunciation 34, Writing 35, Progress 36 and Community 37. Learner selects an instructional session 24, instruction commences 25, the learner selects words or phrases for inclusion in the word card database 22 or phrase card database 23 as appropriate, learner then selects a new instructional session or logs off 27 host computer 11.

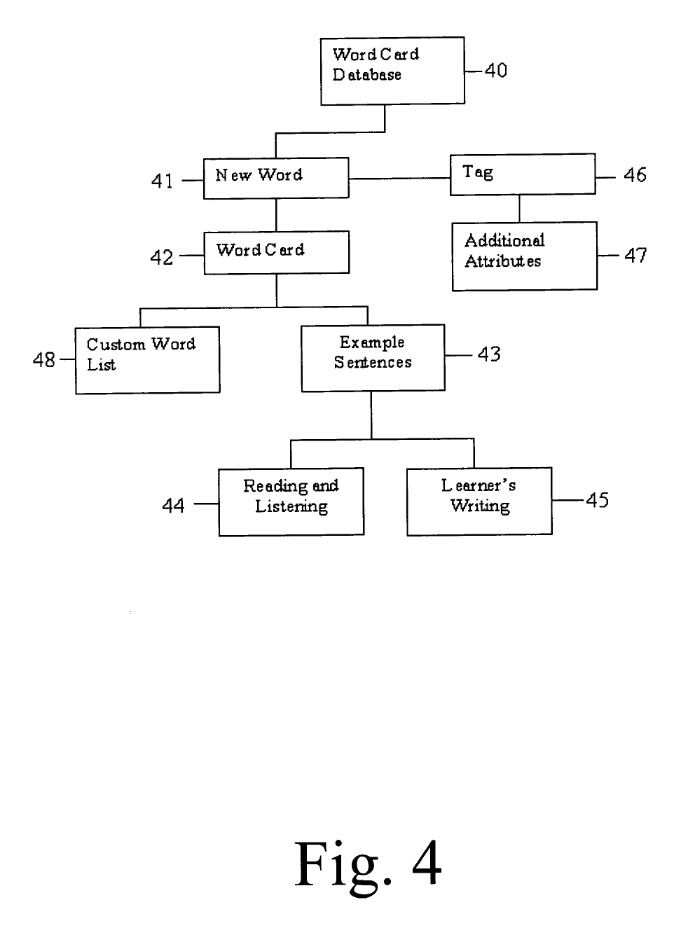

Referring to FIG. 4 the word and phrases 31 instructional session enables the learner to learn new words and phrases by systematically reading and hearing new word and phrases individually and in context. The invention creates a database of word cards 40 for each new word 41. Each word card 42 automatically collects example sentences 43 of the new word from contexts that the learner has encountered in reading and listening 44. The word card 42 also collects example sentences 43 of the correct use of the new word 41 from the learner's writing 45. The word card 42 automatically creates a subject category for the word.

The invention also allows the learner to create a tag 46 for the word to identify some other attribute 47 of the word that is useful to the learner. The learner can also control the frequency with which the word appears in a daily review of words that are being learned. This provides the learner with many different ways of reviewing words that are being studied such as, but not limited to, a daily review, review of sample sentences that originate in familiar content. Additionally, the Learner can chose to place the word card in a customized word lists 48 based on different attributes of the word, including its prefix, suffix or root word. The learner can then use these customized lists in language output (speaking and writing).

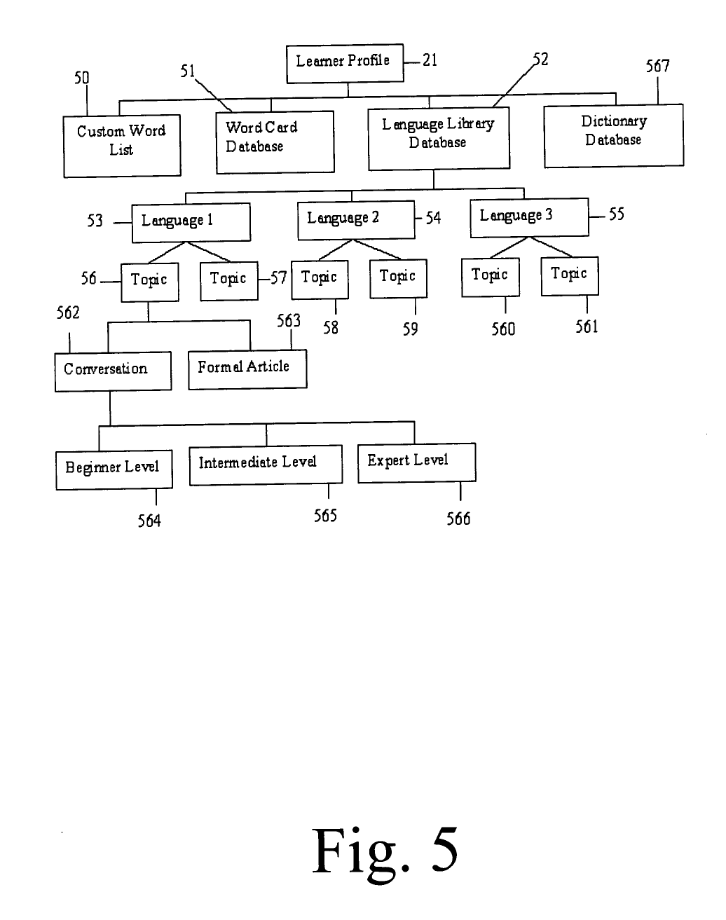

Referring to FIG. 5, there are a number of databases used in this learning method. A learner, after creating a Learner profile 21 the learner has access not only to their custom word list database 50, word card database 51, but to the content center instructional session which allows the learner to chose content from a language library database 52 that consists of a dictionary and many study topics since language is often best learned when a learn is interested in the study topics. The language library is stored in database format and contains of a dictionary 67 and a rage of topics 56-61 covering a range of languages 53-55. The language library contains interesting content covering a wide variety of topics that is produced in live conversation 62 between two native speakers or a more formal article 63. The content center also enables the learner to choose the right level of difficulty from a range of difficulty levels 64-66 found in the language library database 52.

The workdesk session provides a web-based platform where the learner can chose something of interest, listen to it, read it, and download it to their home computer. When the learner is in a workdesk session, it also provides the unique ability allow the learner to vary their reading by using the well known computer cut and paste method to insert or import outside content into the workdesk where the learner can then listen to it or read it at a later time and take advantage of the unique features of the system with this imported content.

The pronunciation session focuses the learner on problem words, sounds and sentence rhythm. In this session the learner will listen repeat and record their own voice for comparison with proper pronunciation and rhythm.

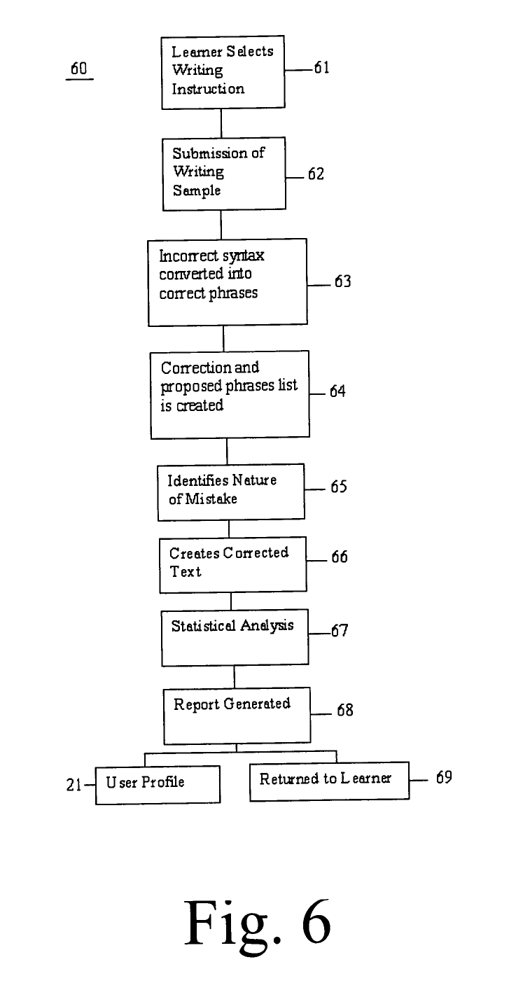

Now referring to FIG. 6 the present invention measures language output as well as language input through the writing instruction session 60 learner where learner first selects the writing instruction session 61 that allows the learner to use what they have learned by submitting their writing for correction 62. The present invention includes a unique writing corrector program which converts incorrect syntax into correct phrases 63, list the corrections and proposes correct phrases 64, identifies the nature of the mistake 65, creates a corrected version of the written text 66 to compare with the original, and develops an ongoing statistical analysis 67 of the kinds of errors made by the learner and the frequency of errors.

The writing sample and report 68 generated by the word corrector is then return to the learner 69 and stored in the learner profile 21. In this way the learner and the teacher can focus on the most frequent kind of syntactical errors and monitor his/her progress. The learner can also integrate the language output activity with the vocabulary acquisition and reading/listening activities of the program as both share the same database of words and phrases

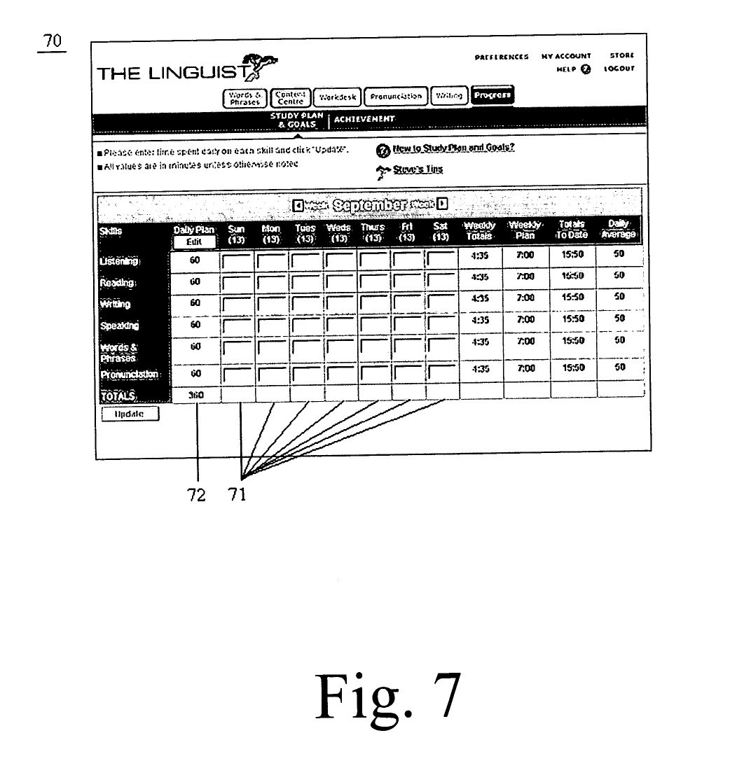

Now referring to FIG. 7, the progress instruction session 70 allows the learner to track their progress through a number of categories. The learner can track the time 71 they spend working on learning the new language, set goals 72, and design a daily plan of study. The database of word cards allows an ongoing measurement of words learned and words known. This database allows the learner to choose new content that is appropriate to his/her level. The measurement of words known and learned can be compared to the learner's own goals and to the record of other learners. The invention also measures how often the word has been encountered (passively learned) and used (actively learned) in writing. The learner's progress report is also stored in their learner profile 21 and can be shared with an optional online coach.

If the learner chooses to use a language teaching coach, the learning method provides the learner with a weekly one on one session with their coach over the web based system, writing correction and analysis by their coach and a weekly report created by the coach detailing and analyzing the learner's progress.

It is widely recognized that languages are learned more effectively in the form of blocks of words that naturally belong together in lexical phrases rather than by using the out-dated model of learning grammar and vocabulary as separate activities. The invention makes it possible for the learner to save useful phrases and create phrase cards in the same manner as the word cards described above.

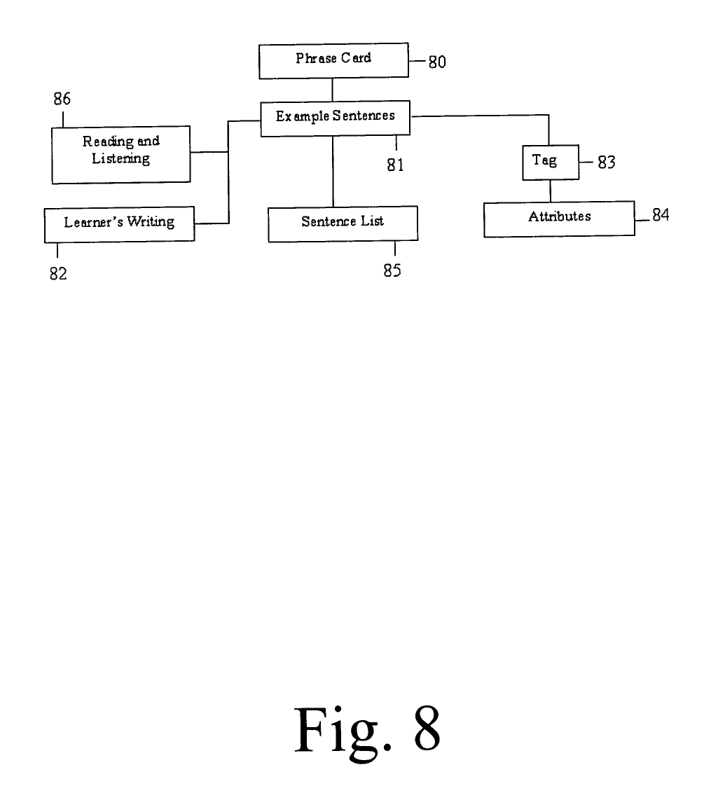

Now referring to FIG. 8 each phrase card 80 automatically collects example sentences 81 of the new phrase from contexts that the learner has encountered in reading and listening. The phrase card also collects example sentences of the correct use of the new phrase from the learner's writing 82. The phrase card automatically creates a subject category for the phrase. The invention also allows the learner to create a tag 83 for the phrase to identify some other attribute 84 of the phrase that is useful to the learner. The learner can also control the frequency with which the phrase appears in a daily review of phrases that are being learned. This provides the learner with many different ways of reviewing phrases that are being studied such as, but not limited to, the daily review, review of sample sentences that originate in familiar content.

The creation of customized lists 85 based on different attributes 84 of the phrase, including the component words that are collocated in the phrase. The learner can then use these customized lists 85 in language output (speaking and writing). The invention integrates all aspects of language learning. The web-based community provides opportunities for learners to meet and communicate on subjects of interest, with coaches and with other learners.

In another embodiment learning system of the present invention is designed to help people learn from audio and digital text. The learning system of the present invention is effective in any learning situation where language is the main medium of instruction because the learning system of the present invention requires material to be presented in audio and digital text format. The learning system of the present invention requires that any material that can be presented in audio and digital format be used as study material.

The learning system of the present invention ties new concepts and information to context. It ensures that words and phrases are regularly reviewed while making it possible to learn without memorizing. As previously disclosed, Learners set their own goals and are able to monitor and analyze their written output. The learning system of the present invention measures learners' activities and progress towards their goals.

These and other features of the learning system of the present invention are effective in most learning situations where language rather than demonstration is the main medium of instruction.

The learning system of the present invention was originally designed for the purpose of foreign language development and incorporates the ability to listen to, read, and learn from the real language. Database technology allows for systematic review of new vocabulary until it is learned. Vocabulary database enables the displaying of examples tied to content from the learners own library of study material. Learner can maintain database of words and phrases and customize study lists of these words for review. Learner submits writings that are corrected and analyzed and returned with a statistical analysis. The whole learning process is accurately measured and statistics are kept. Learners' progress towards targets he has set is tracked and encouraged by system.

The learning system of the present invention enables learners in special needs education such as literacy programs, adult education, and other specifically for people with reading difficulties to hear and listen to meaningful content of their choice, and then methodically learn words and phrases from this content by using language learning engine of the present invention. This combination of listening, reading and word and phrase review increases retention and confidence. By systematically learning new words and phrases in context, not only are language skills improved, but the ability to understand new concepts is enhanced.

With respect to academic coursework such as high school courses, university and college courses (especially those in humanities), and vocational and technical courses, the subject of study is not the language itself, but course material of interest to learners and relevant to their studies. Using the language-learning engine ensures that facts and concepts are more easily retained because they are learned in context. Learners can receive course material, whether lectures, textbooks or supplementary course material, in audio and text format. Learners can listen again to lectures to improve comprehension. They can listen to audio recordings of their text material. They can read through lecture transcriptions or textbook material and identify, look up, and save key words, phrases, and concepts. These key words, phrases, concepts are then utilized in the review section which also draws in other examples using these terms from all course material in the system. In this way students can quickly view multiple examples from their reading incorporating the key points they are trying to learn.

Reinforcement from multiple sources speeds up and enhances the learning process. The student has the instant ability to test himself on all key points. This is a kind of electronic note-taking system, which can tie all notes together and present them for quick review. Once the student understands the concepts he can listen to the lectures again or to recorded text material to reinforce comprehension. The goal setting, testing and measurement features of the learning system of the present invention provide learners with an effective learning methodology and on going feedback.

The main objective of the present invention is to create a website which will be the place to come to learn languages on the Internet. The goal is to have something that is free for Learners and that is fun and attractive. In order to make it fun, the initial contact and main point of attraction will be the content library. A content area/library/magazine will be presented that will encourage learners to want to select and study content and keep coming back to do so.

Learners will be able to freely download the software application and engine previously described with limited access to some content and additional features. The free software is essentially the learning engine previously disclosed. Learners are able to download the software freely and access sponsored linguist library content. They will be able to read, listen, and save words and phrases from this content. They will be able to create custom lists of their words and phrases and see useful statistics on all the items they have selected. They will post questions on a Forum and be able to measure their progress.

In the free version, the importing of content will not be included but will be available only on a fee basis. The desktop software application only connects to the system server to download new content. Thus, if the free software application becomes ubiquitous increasing support costs are minimized. The software will be available in multiple languages such as, but not limited to: English, French, Chinese, Japanese, Spanish, German, and Italian.

The result will be a software program comprised of a fun, simple interface encouraging sharing. Learners will spread the software since the more Learners there are, the better the language exchange will work. Many people know people in other language groups who would they would encourage to join the language exchange.

There will be a points system based on Learner activity. Learners may purchase points in set denominations which they can then use to purchase additional services available as previously described in the full software program and system. Additional services will include writing correction, tutoring, conversations with system tutors, conversations with each other, pronunciation correction, oral sample correction, testing. Some of this functionality will be provided by tutors only but some may also be provided by learners to learners. Points may also be used to purchase items in an online store.

Points can be earned, purchased and spent in a variety of ways. Learners get points every time they save words or phrases (also referred to as Active LingQ's) or using them in writing and speaking. Learners get a fewer number of points for words in the first and second 1000 words. They do not get points the second time they choose a term.

Every time a Learner uses a term from their Active LingQ's in their writing they will get points. Points will be awarded depending on what status the terms have. Words that get tested correctly receive points. A sliding points scale will be used as the word moves up in status. Incorrectly tested words cost the same number of points.

On content forums, each question will cost a fixed number of points. The Learner asking the question then awards the points to the Learner answering based on the quality of the answer. The asking Learner can either award all points to one answering Learner or split the points among many answering Learners. A tally of top forum “tutors” will be visible in the forum ranked by forum point totals.

Writing correction will be posted on the “tutor exchange” where it will cost a fixed number of points to have it corrected. This system will receive a percentage of the fee and send the remaining points to the corrector. The corrector may be a paid tutor within the system but may also be another Learner or freelance tutor.

Points will be charged for speaking system tutors 1 on 1 or as a group. Points will also be charged when speaking to other native speaker Learners. The system will not take a percentage of these points when sent to other Learners but will require points payments so that Learners are motivated to earn points by downloading content and creating LingQ's.

Points will also be charged for spoken or pronunciation sample correction. These samples will be posted on the tutor exchange and we will get a cut of the points. Points can be redeemed for cash, used to purchase testing, personal tutoring, or in the content store.

In alternative embodiments, points will be awarded every time a Learner updates their “known words” list and the first time a content item is burned to CD or transferred to and MP3 player.

Rating systems will be established to grade quality of tutoring done by other learners and to rate content. Learners can in fact earn income from tutoring other Learners and will be paid out as they achieve certain minimums. Other learners who provide tutoring will likely be native speakers of the target language who are learning another language on the system.

In addition to purchasing points, learners can earn points through various activities such as: saving words or phrases and using them in writing and speaking, testing correctly their saved words or phrases, or answering questions on the forum and being awarded points.

Learners will be provided an incentive to sign up other Learners/Learners for which they will receive a fraction of the number of points earned from the Learner/Learners that they sign up as well.

All the activities performed by a Learner from sending of messages to his tutor or other Learners, to writing samples, to spoken samples, to forum questions will be able to be sent through correction and will be able to be posted to a Learner's personal blog. This blog can be made private, for Learners only or viewable by the general public. All posts can have their status set individually and Learners can also just post directly in their own languages.

Learners will be given the ability to download other software programs for a trial initially, they will then be asked to buy it, and any sales made will result in a commission earned by the system. If they choose not to download the software they will be offered links to free resources on the web or the system may be adapted to provide minimal equivalent services.

Sponsors of content will pay a commission to the system every time their sponsored content gets downloaded. A lesser charge will be incurred when the content is previewed. Sponsored content can either be infomercial type content or it can be unrelated content presented by a sponsor or anything in between as long as it is interesting to the learner or it won't be downloaded.

The system will enable learners to create content for each other in some form as well thereby enabling all forms of electronic transmissions, if digital text is provided, to be used as language learning materials

The Forum is major element to the online community. The system will be available with multiple languages and therefore the Forum will be multilingual. Essentially it will be a language exchange where Learners of different language groups will answer each others language questions. System tutors will not answer the questions on the Forum or at least are not obliged to, although at the beginning they may.

In an alternative form embodiment the system will have a paragraph, or at least a sentence on either side of the sentence containing the word or phrase in question, appear with the forum question. This will provide more context for the person answering the question.

A content area will reside on the system server. Learners will go to the content area through their desktop client. When a Learner connects to download content the Learner is identified and his preferences determine what content the Learner initially sees. Thereafter the Learner is free to browse. Also when the Learner connects to server his stats are updated on the system.

Content is displayed based on category preferences of Learner, demographic of Learner, vocabulary level of Learner, and previous selections. (i.e. additional parts of previously selected material). All content will be broken down into three-minute sections that will have a sponsor attached. When an item is clicked on it opens a preview of the item where a Learner can see relevant statistics, listen and read an excerpt and see ratings and reviews of content items. If the Learner likes the item they can download it to their desktop. Alternatively, if the content is not sponsored it can be sold on a points cost per download basis.

Category preferences can either be identified during enrollment or can be learned by the system over time. Initially all categories will randomly appear and as a Learner selects items from certain categories over time, the system will recognize this and deliver content from these preferred categories. Demographic info will be used to direct sponsors content to specific, limited audiences. Initially target audiences will be quite broad but over time this could get more and more refined. Emails should go out regularly advising Learners of new content directed at them. Can click to download from email.

The system will recognize the vocabulary level of Learners and then direct content at them depending on their present vocabulary level and list of terms that they are currently learning. Optimal new words and words I am learning levels will be set and targeted. Initially vocabulary levels will be based on Learners own assessment of their level but over time will be based on the system's evaluation of their vocabulary level. Content that most closely fits the optimum new words and words I am learning profile will be displayed but in all likelihood, a range of content will appear until the library is sufficiently large.

Where content has been broken down into parts, and a Learner has selected one or more parts, additional parts of the content should be displayed for that Learner. As time goes on and additional parts are not selected the system should recognize this and start displaying other content instead. In addition all content will be rated and reviewed. Content ratings may eventually be used to determine whether content gets displayed.

The system will measure how many previews each content item receives since the preview will contain the sponsor's logo and indicate whom it has been sponsored by. The sponsor will get charged a small fee every time their content is previewed. The system will also measure how often the content is downloaded and once again the sponsor will be charged for each download.

Sponsors will sponsor content which will take the form of either a three minute infomercial, a 15-20 second sponsor's message which can be added on to the system's content or content the sponsor creates which also included a sponsor's message at the end. All sponsor's messages and/or content will be in audio and text form and in the case of the sponsor's message will be attached to the audio and text of the content. Or maybe sponsors will sponsor different “wings” of the library where all there content is displayed. In this case sponsors will be charged a basic advertising charge per 1000 impressions in addition to preview and download charges.

Content will be arranged on the Learners desktop by category and will be navigable through a folder tree system, including an archive area. All content will also be attractively displayed with pictures, sponsor's logos, and preview info on the desktop. Once content has been downloaded it should no longer appear in the library for that Learner.

The system will also have a paid content section where audio ebooks, and audio newspapers, magazines etc. can be sold. Once purchased by a Learner, these products will be downloadable from system site and compatible with LingQ.

An excerpt, which would be a content item, may be provided free to all Learners for preview with the complete work available for sale through the content store or through affiliate links to the provider's website. Once confirmation of purchase from a supplier is received, the system will download the purchased content to the Learner's desktop.

Imported content will be an upgrade feature. It will not be part of the free basic functionality. If Learners subscribe to an upgraded service they can import content.

In another embodiment Learners are able to submit content for possible addition to the library. Content should be in both text and audio form and points will be awarded to all providers of approved content. Content submitted by our members will be rated to determine suitability.

A text reading area is provided that is clean with a picture and sponsor's logo displayed at top of the content. One row of buttons and commands at the top of the scrolling window including a LingQ button, Update Known Words button and link count, progress bars, stream audio icon and any other key commands or statistics. Every time a LingQ is saved a sound like a bell or a vault door closing shut is played. This can be an option that can be set by the Learner. At the same time the LingQ total should update automatically.

When downloading LingQ, Learners will also download a 1-month trial of Babylon. Babylon is a software program that is able to automatically recognize words, compound words and phrases just by control clicking on any part of the term. This system will be able to, once a term is highlighted, create a LingQ card for the highlighted term. Then the LingQ card will open with Babylon open beside it. The latest Babylon version allows cutting and pasting so learners can immediately cut and paste relevant info into the notes area. Anything in the Notes area will appear in the list of Active LingQs (words I am learning).

Learners will LingQ all terms they don't understand. A term is a word or a phrase. A LingQ is created for each term. This is essentially the current word card with a few modifications. Selected terms will be saved and automatically several words to either side of the term will be captured and will appear as an editable field in the LingQ window. All LingQ's will have the option to ask for an explanation. All questions will be posted to Forum to be answered by LingQ community Learners. There will be a link on the LingQ card to show all examples of the term in Learner's content. The learner will have the option to find examples of the term in use in the full Linguist Library thereby enabling him to identify new content items to select to help reinforce new vocabulary under review. The status of the card will be shown in a dropdown from 1-7, 1=New, 7=Known and can be changed here and saved.

After the month trial Babylon will have to be purchased. If Learners already have Babylon it will be automatically integrated into LingQ. If they have a previous version that doesn't allow cutting and pasting they will be asked to upgrade. If they don't want to upgrade or don't want Babylon, the system will provide a link to dictionary.com or similar websites where they can go and cut and paste notes back into their cards which is much more inconvenient and much less useful than using Babylon.

On the main LingQ page Learners will be able to stream audio. There will be a separate section called Burn/Transfer where Learners will go to transfer/burn audio files onto mp3 players or CD's. Obviously audio files are automatically downloaded when content is selected from content library and is available for burning/transfer. As much as possible, transfer to an audio device or burning is automated and easy to use.

LingQ Review is a website page within the system where all functionality from current words I am learning, phrases I am learning, and word and phrase review will be combined. Learners will be able to set filters to generate a list of terms, they will be able to print this list, test this list. They will see the term, phrase, and notes for each term and can click to see the sentence and more examples if they like and can update the status of the terms in the list also.

New terms entered in and not from content automatically link to all examples in Learner's content. All terms saved from writing correction should pull in all examples from Learner's content and should automatically have the notes from the mistake area copied to their LingQ card.

Learners will be able to submit writing, which can then either be corrected by fellow Learners or by a certified Linguist tutor. Of course Learners will pay a premium for correction by a system tutor. Also only Learners who are native speakers of the target language will be able to correct. Learners will write on their desktop and then upload the writing sample for correction. Writing samples will be downloaded to other Learners or tutors desktop for correction before being uploaded and returned to the writer.

When writing is submitted it is posted on the tutor exchange. Writing correctors, both freelance and those certified by the system can then bid on the correction job. All tutors will be rated and reviewed by the Learner who submitted his writing. This will help Learners assess correctors and help them select someone. After collecting bids, the Learner can then choose a corrector and they will be able to download the writing for correction.

Corrections must be completed and sent back within 24 hours. If corrections are not completed and returned within 24 hours they may be awarded to a new corrector and the original corrector will receive negative feedback/rating. If unable to complete it on time the corrector must let the Learner who submitted it know before the 24 hour period has expired and it is up to that Learner whether to give negative feedback about the corrector.

All writing is corrected in some manner, including writing samples, forum posts, emails to tutor and blog posts. Learners have the option to post all writing they do on the system into their personal LingQ Blog, including any forum posts, questions etc. This blog can be made public or kept private. Learners can of course post directly to their blog in their own language.

At every place where Learners can submit writing there is a link to the writing correction exchange. For instance in the forum when making a post there is a link to submit the post for correction. The same happens in the blog post area. Blog postings should be done on the desktop and then corrected and then posted to the Blog. Learners will be able to post directly to the blog, as well.

Learners are also able to connect with fellow Learners to speak. All Learners will sign up for Skype or an equivalent service. Learners will indicate whether they want their Skype names to be visible, whether they want to be contacted, etc. Learners will be able to talk to native speakers of their target language.

Each conversation will cost a fixed number of points, which will go to the native speaker's account. If Learners want to exchange conversation they will have to buy it first, talk for a while and then hang up and have the other person call back to send the points back the other way. This encourages people to spend and use points as much as possible.

Learners will also be able to speak 1 on 1 with Linguist tutors and in group discussions with Linguist tutors. Both of these services will cost differing numbers of points. All calls and conversations should originate and occur in the desktop application, which is integrated with Skype as opposed to occurring within the Skype client.

The basic pronounce features are retained as previously described except that in the present invention the desktop application will tie in to the Learners sound program like Windows voice recorder and there won't be an applet to download.

Learners are able to submit voice samples for structural and pronunciation analysis. Speaking samples can be posted on the tutor exchange and bid on in the same way as the writing correction. Once a tutor has been selected the sample is uploaded and sent to that tutor for correction using a similar system to the writing correction. An intermediate step of transcription will have to occur first for which the system will be compensated. The Learners spoken sample will be in response to a quick question they will receive and then they will have limited time to prepare their answer before submitting the sample.

In an alternative embodiment pure pronunciation analysis involves reading, recording and submitting either a corrected writing sample or piece of content for which the tutor would receive in text as well as audio. The pronunciation analysis would be done using the same basic writing/speaking correction platform and tutor exchange system.

Learners will be able to track all the things they can track now in a Measure section via graphs with goals and actual values. If the Learner signs up for Personal Tutoring service they will also receive progress reports.

Personal Tutoring will also be offered as a fully paid service. This will include a weekly 1 on 1 conversation with the tutor, the ability to email or Skype chat with the tutor, have the tutor correct the Learner's writing and receive reports, guidance and support from the tutor. Also the tutor will answer the Learner's forum questions.

A testing service is offered to achieve different certification levels. This is again a paid service provided by system. Tests will include tests drawn from the Learners known terms and a written and speaking sample. Both the writing and speaking sample will consist of a randomly chosen pop up question to which the Learner must respond after being given a short time to compose his thoughts. Corrections will be done in the usual way with Learners being graded on accuracy, logic and richness. Obviously spoken samples will require transcription but should be no more than a few minutes long. Successful tests will receive a nice certificate in the mail.

Although the description above contains many specificities, they should not be construed as limiting the scope of the invention but as merely providing illustrations of some of the presently preferred embodiments of this invention. Thus, the scope of the invention should be determined by the appended claims and their legal equivalents, rather than by the examples given.

The embodiments of the invention in which an exclusive property or privilege is claimed are defined as follows:

1. A computer-implemented method for providing language instruction comprising:
invoking a web browser;
downloading a desktop software application to a learner computer;
logging a learner computer into a host system to commence a learning session; and
creating a learner profile in a personal database for establishment of category preferences that can either be identified during enrollment or can be learned by the system over time;
accessing a language library database and content database wherein content is either downloaded free from a sponsored content database or purchased if provided by a content seller;
displaying to learner a control panel providing the learner with the option of choosing language instruction sessions; with the
learner engaging in a selected instruction session; where the language is the main medium of instruction as said learning system requires material to be presented in audio and digital text format.

2. The computer-implemented method for providing language instruction of claim 1 wherein
learners are able to download freely from a sponsored content library, or
learner are able to read, listen, and save words and phrases from said content library;
learners able to create custom lists of words and phrases and see useful statistics on all the items they have selected.

3. The computer-implemented method for providing language instruction of claim 2 wherein
content is displayed based on category preferences of the learner, demographic of learner, vocabulary level of learner, and previous selections;
content is arranged on the Learners desktop by category and is navigable through a folder tree system,
when content is selected a preview of the item is shown where a Learner can see relevant statistics, listen and read an excerpt and see ratings and reviews of content items;
once content has been downloaded it no longer appear in the library for that Learner; content is delivered in three-minute sections and have a sponsor attachment.
learners may post questions on a Forum;
learners are able to measure their progress;
additional services include writing correction, tutoring, conversations with tutors, conversations with each other, pronunciation correction, oral sample correction, and testing.

4. The computer-implemented method for providing language instruction of claim 1 wherein the importing of content is available only on a fee basis and is enabled by a desktop application that only accesses the language library database and the content database to download new content.

5. The computer-implemented method for providing language instruction of claim 1 wherein said software applet is available in English, French, Chinese, Japanese, Spanish, German, and Italian languages.

6. The computer-implemented method for providing language instruction of claim 1 further comprising a points system based on Learner activity where Learners may earn or purchase points in set denominations which they can then use to purchase additional services.

7. The computer-implemented method for providing language instruction of claim 3 wherein
learners earn points every time they first save words or phrases or using them in writing and speaking;
learners earn points or a decreasing scale;
every time a Learner uses a saved term in their writing they earn points;
points are awarded depending on what status of terms in the system, words that get tested correctly receive points while corresponding incorrect terms lose an equal number of points; and
a sliding points scale is used as words change in status.

8. The computer-implemented method for providing language instruction of claim 3 further comprising content forums wherein
a learner may ask questions and each question will cost a fixed number of points;
the learner asking the question awards the points to an answering learner based on the quality of the answer;
the asking learner can either award all points to one answering learner or split the points among many answering learners.

9. The computer-implemented method for providing language instruction of claim 3 further comprising a tutor exchange wherein a learner may post a audio files or written text for review and correction for a fixed number of points, wherein the system collects a percentage of the points and sends the remaining points to the corrector; the corrector may be a paid tutor within the system, another learner, or a freelance tutor.

10. The computer-implemented method for providing language instruction of claim 3 wherein learners may be charge points for the following actions:
speaking system tutors 1 on 1 or as a group;
speaking to other native speakers learners;
spoken or pronunciation sample correction;
saving words or phrases and using them in writing and speaking;
reviewing correctly others saved words or phrase;
or answering questions on the forum and being awarded points;
learners earn a fraction of the number of points earned from any additional learners referred to they system; and
accepted content for addition to the library.

11. The computer-implemented method for providing language instruction of claim 3 further comprising a rating systems to grade quality of tutoring done by other learners and to rate content.

12. The computer-implemented method for providing language instruction of claim 3 further comprising a personal learner blog wherein
all the activities performed by a learner are sent through correction and will post to a Learner's personal blog;
said blog can be made private, for learner only or made viewable to the general public.

13. The computer-implemented method for providing language instruction of claim 1 wherein sponsored content takes the form of either a three minute infomercial with a 15-20 second in audio or text form.

14. The computer-implemented method for providing language instruction of claim 10 wherein
said forum is available in a plurality of languages where Learners of different language groups will answer each other's language questions;
at least a sentence on either side of the form question containing the word or phrase in question, appears with the forum question.

15. The computer-implemented method for providing language instruction of claim 7 further comprising means for learners to submit writing which
can then either be corrected by fellow Learners or by a certified Linguist tutor;
only learners who are native speakers of the target language or system tutors are able to correct;
learners write on their desktop and then upload the writing sample for correction;
writing samples are then downloaded to another Learners' or tutors' desktop for correction before being uploaded and returned to the writer;
when writing is submitted it is posted on the tutor exchange;
writing correctors, then bid on the correction job;
after collecting bids, the Learner can then choose a corrector and they will be able to download the writing for correction;
all tutors will be rated and reviewed by the Learner who submitted his writing as a means to help other Learners assess correctors and help them select someone.

16. The computer-implemented method for providing language instruction of claim 3 further comprising a review website page within the system where all where Learners will be able to set filters to generate a list of terms, see the term, phrase, notes for each term and can click to see the sentence and more examples if they like and can update the status of the terms in the list.

17. The computer-implemented method for providing language instruction of claim 3 wherein said desktop software application includes a software program that is able to automatically recognize words, compound words and phrases just by selecting any part of the term to create a word or phrase cards from highlighted terms.

18. The computer-implemented method for providing language instruction of claim 17 wherein said recognition software program will open with the word or phrase card and allow cutting and pasting so learners can immediately cut and paste relevant information into the notes area of the word or phrase card.

19. The computer-implemented method for providing language instruction of claim 9 wherein learners are able to submit voice samples for structural and pronunciation analysis;
the Learners spoken sample is response to a quick question they will receive and then they will have limited time to prepare their answer before submitting the sample.
speaking samples are posted on the system's tutor exchange;
once a tutor has been selected the sample is uploaded, an intermediate step of transcription occurs, and sent to that tutor for correction;

20. The computer-implemented method for providing language instruction of claim 1 further comprising a testing service requires:
tests drawn from the Learners known terms and a written and speaking sample;
both the writing and speaking sample consist of randomly chosen pop up questions to which the learner must respond after being given a short time to compose his thoughts;
corrections are done after each answer and Learner is graded on accuracy, logic and richness;
spoken samples require transcription;
successful test results are rewarded will a certificate and online rating.
